(19) United States
(12) Patent Application Publication
(10) Pub. No.: US 2008/0231656 A1
(43) Pub. Date: Sep. 25, 2008

(54) INK-JET IMAGE FORMING APPARATUS AND MAINTENANCE METHOD THEREOF

(75) Inventor: Soo Hyun Kim, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-Si (KR)

(21) Appl. No.: 12/022,445

(22) Filed: Jan. 30, 2008

(30) Foreign Application Priority Data
Mar. 20, 2007 (KR) 2007-27101

(51) Int. Cl. B41J 2/165

(52) U.S. Cl. 347/33

(57) ABSTRACT

An ink-jet image forming apparatus and a maintenance method thereof include an ink-jet head having a nozzle portion to eject ink, a printing medium feeding device to feed a printing medium to face the ink-jet head, a printing medium guide to guide the printing medium, a wiper to move while contacting the nozzle portion to wipe the nozzle portion, and a guide driving unit to tilt the printing medium guide to prevent a foreign substance coming off the wiper from being attached to a printing medium contact portion of the printing medium guide when the wiper wipes the nozzle portion.

### CROSS-REFERENCE TO RELATED APPLICATIONS

This application claims priority under 35 U.S.C. §119(a) from Korean Patent Application No. 2007-0027101, filed on Mar. 20, 2007 in the Korean Intellectual Property Office, the disclosure of which is incorporated herein in its entirety by reference.

### BACKGROUND OF THE INVENTION

1. Field of the Invention

The present general inventive concept relates to an image forming apparatus, and more particularly to an ink-jet image forming apparatus and a maintenance method thereof, to form an image by ejecting an ink onto a printing medium.

2. Description of the Related Art

An image forming apparatus is an apparatus that prints a black and white image or a color image on a printing medium, e.g., paper, according to an image signal, for example, a laser printer, an ink-jet printer, a copying machine, a multi-function printer, a fax machine, etc. An image forming apparatus is classified as an electrophotographic type in which a beam is scanned onto a photosensitive body to form an electrostatic latent image and a developer is adhered to the electrostatic latent image to transfer the same onto a printing medium, or an ink-jet type in which a liquid type ink is ejected onto a surface of a printing medium according to an image signal.

The ink-jet image forming apparatus is provided with an ink-jet head which ejects an ink according to an image signal. The ink-jet head is provided with a nozzle portion through which an ink droplet is ejected according to the image signal to print letters or pictures on a printing medium. The ink-jet head is classified as a shuttle type ink-jet head which ejects an ink while reciprocatingly moving in a printing medium feeding direction (sub scanning direction) and a direction perpendicular to the feeding direction (main scanning direction), or an array type ink-jet head which is provided with a nozzle portion having a length corresponding to a width of a printing medium and can achieve line printing. The ink-jet image forming apparatus including the array type ink-jet head is configured such that the ink-jet head is in a fixed state and only the printing medium moves in the sub scanning direction. Accordingly, the ink-jet image forming apparatus has an advantage that a structure of a driving device is simple and high speed printing can be achieved.

The shuttle type ink-jet head and the array type ink-jet head are commonly provided with nozzle portions to eject an ink. The nozzle portion includes a plurality of nozzles which are directed toward a platen which forms a printing medium feeding path. An ink drop, which is not ejected, remains on the nozzle portion. However, during a non-printing state, if the nozzle portion is exposed to air, the residual ink drop on the nozzle portion may be subject to lithification, or a foreign substance such as a dust in the air may be attached to the ink drop. Thus, hardened ink or the foreign substance prohibits smooth ink ejection, causing a deterioration of printing quality, and can even clog the nozzle, making the printing operation impossible.

To solve this problem, the ink-jet image forming apparatus is provided with a maintenance device to perform maintenance operations, such as spitting, wiping and capping. The spitting is to eject the ink several times at a regular cycle to remove the ink having a high viscosity. The wiping is to wipe off the foreign substance such as an ink drop from the nozzle portion. The capping is to cap and shield the nozzle portion from outdoor air. A wiper used for a wiping operation, and a cap used for a capping operation, or the like are maintenance devices.

If the printing operation is completed, the wiper and the cap operate in sequence to respectively perform the wiping and the capping operations. That is, if the ink ejection is stopped after completion of the printing operation, the wiper moves forward and backward in the sub scanning direction and wipes a surface of the nozzle portion to remove the foreign substance from the nozzle portion. Thereafter, the cap moves to cap the nozzle portion to shield the nozzle portion from outdoor air.

However, in the above conventional ink-jet image forming apparatus, while the wiper is separated from the nozzle portion after completing the wiping, the ink left on the wiper may be sputtered to a front and rear of the nozzle portion. If the wiped ink is sputtered, the printing medium feeding path is contaminated with the ink. Thus, the printing medium fed in the next printing operation is smeared with the wiped ink, thereby deteriorating printing quality.

### SUMMARY OF THE INVENTION

The present general inventive concept provides an ink-jet image forming apparatus and a maintenance method thereof capable of preventing a printing medium feeding path from being contaminated with a wiped ink although the wiped ink is sputtered.

Additional aspects and/or utilities of the present general inventive concept will be set forth in part in the description which follows and, in part, will be obvious from the description, or may be learned by practice of the general inventive concept.

The foregoing and/or other aspects and utilities of the general inventive concept may be achieved by providing an ink-jet image forming apparatus including an ink-jet image forming apparatus including an ink-jet head having a nozzle portion to eject ink onto a printing medium, a wiper to wipe the nozzle portion of the ink-jet head, and a printing medium guide movable between a first position to guide the printing medium and a second position to prevent a foreign substance from the wiper adhering to a printing medium contact portion of the printing medium guide. The ink-jet image forming apparatus may further include a guide driving unit to tilt the printing medium guide to prevent a foreign substance coming off the wiper from being attached to a printing medium contact portion of the printing medium guide when the wiper wipes the nozzle portion.

The guide driving unit may tilt the printing medium guide when the wiper approaches the printing medium guide while wiping the nozzle portion.

The guide driving unit may rotate the printing medium guide at a predetermined angle to raise a portion of the printing medium guide adjacent to the ink-jet head.

The printing medium feeding device may include a feed roller to rotate to feed the printing medium, and the guide driving unit may rotate the printing medium guide by a rotational force of the feed roller.

When the feed roller rotates in a forward direction to feed the printing medium, the guide driving unit may be in a non-operating state, and when the feed roller rotates in a reverse direction, the guide driving unit may operate to rotate the printing medium guide at the predetermined angle.

The guide driving unit may include a taper protrusion provided at the feed roller having an inclined surface protruding gradually from a surface of the feed roller and a latching surface formed at an end of the inclined surface, and a latching member provided at the printing medium guide having an inclined portion and a latching portion connected to an end of the inclined portion. When the feed roller rotates in the forward direction, the inclined portion may contact and slip on the inclined surface, and when the feed roller rotates in the reverse direction, the latching portion may be caught by the latching surface.

The inclined portion may be elastically deformable. When the inclined portion contacts the inclined surface, the inclined portion may be pushed outwardly from the feed roller.

The foregoing and/or other aspects and utilities of the general inventive concept may also be achieved by providing a maintenance method of an ink-jet image forming apparatus, the method including wiping a nozzle portion of an ink-jet head by a wiper, and tilting a printing medium guide to prevent a foreign substance coming off the wiper from being attached to a printing medium contact portion of the printing medium guide when the wiper wipes the nozzle portion.

The foregoing and/or other aspects and utilities of the general inventive concept may also be achieved by providing a printing medium guiding device usable with an ink-jet image forming apparatus, the device including a printing medium guide to guide a printing medium, and having a printing medium contact portion to contact the printing medium, wherein the printing medium guide is movable between a first position to guide the printing medium and a second position to prevent a foreign substance from a wiper of the ink-jet forming apparatus from adhering to the printing medium contact portion of the printing medium guide.

The printing medium guide may move to the second position corresponding to an initial stage of a wiping operation.

The initial stage of the wiping operation may be a movement of the wiper towards the printing medium guide.

The foregoing and/or other aspects and utilities of the general inventive concept may also be achieved by providing a method of cleaning an ink-jet image forming apparatus, the method including determining an initial stage of a wiping operation of an ink-jet image forming apparatus, and moving a printing medium guide to a position to prevent a foreign substance from a wiper to adhere to a printing medium contact portion of the printing medium guide corresponding to the determination of the initial stage of the wiping operation.

A moving of the wiper toward the printing medium guide may be the initial stage of the wiping operation.

The foregoing and/or other aspects and utilities of the general inventive concept may also be achieved by providing computer-readable recording medium having embodied thereon a computer program to execute a method, wherein the method includes determining an initial stage of a wiping operation of an ink-jet image forming apparatus, and moving a printing medium guide to a position to prevent a foreign substance from a wiper to adhere to a printing medium contact portion of the printing medium guide corresponding to the determination of the initial stage of the wiping operation.

### BRIEF DESCRIPTION OF THE DRAWINGS

These and/or other aspects and utilities of the present general inventive concept will become apparent and more readily appreciated from the following description of the embodiments, taken in conjunction with the accompanying drawings, of which:

FIG. 1 is a constitutional view schematically illustrating an ink-jet image forming apparatus in accordance with an exemplary embodiment of the present general inventive concept;

FIG. 2 is an exploded perspective view illustrating components of the ink-jet image forming apparatus in accordance with an exemplary embodiment of the present general inventive concept;

FIGS. 3 to 5 are side views illustrating a maintenance method of the ink-jet image forming apparatus in accordance with an exemplary embodiment of the present general inventive concept; and

FIG. 6 is a flowchart illustrating a method of cleaning an ink-jet image forming apparatus according to an embodiment of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to like elements throughout. The embodiments are described below in order to explain the present general inventive concept by referring to the figures.

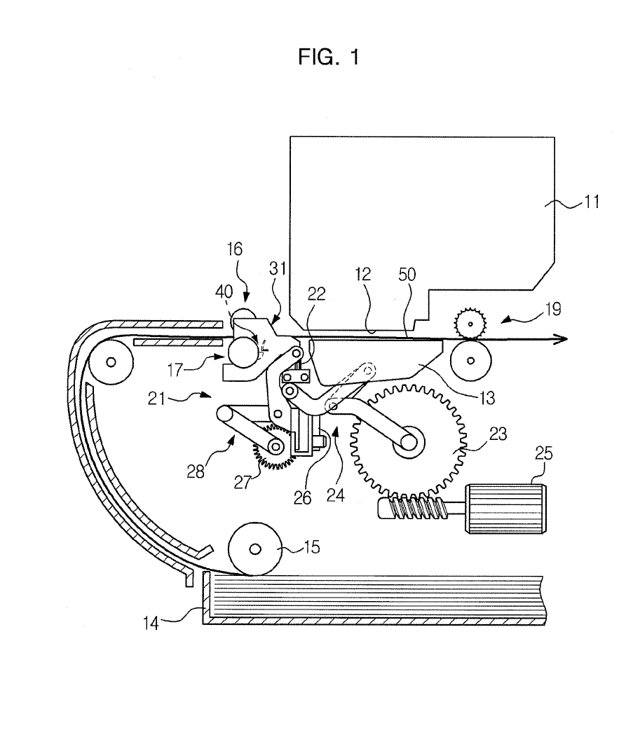

As illustrated in FIG. 1, an ink-jet image forming apparatus according to an embodiment of the present general inventive concept includes an ink-jet head 11 having a nozzle portion 12 to eject ink, a platen 13 provided below the nozzle portion 12 to support a printing medium which is fed, a pickup device 15 to pick up the printing medium loaded on a printing medium supply device 14 sheet by sheet, a printing medium feeding device 16 to feed the picked-up printing medium, for example, to face the ink-jet head 11 such as passing the picked-up printing medium by the ink-jet head 11, a maintenance device 21 to perform a maintenance operation, and a printing medium guide 31 to guide the printing medium which is fed. The maintenance device 21 includes a wiper 22 to wipe the nozzle portion 12, and a cap 26 to cap the nozzle portion 12.

In the above-structured ink-jet image forming apparatus according to the present embodiment, if the pickup device 15 picks up the printing medium loaded on the printing medium supply device 14 sheet by sheet, the printing medium feeding device 16 feeds the picked-up printing medium toward the platen 13. At this time, the printing medium guide 31 guides the printing medium to be fed in a straight manner. If the printing medium reaches the platen 13, the ink-jet head 11 ejects the ink onto the surface of the printing medium according to an image signal to form an image on a surface of the printing medium. Subsequently, the image-formed printing medium passes by the ink-jet head 11. Subsequently, the image-formed printing medium is discharged by a printing medium discharge device 19 mounted on a downstream side of the ink-jet head 11 in a printing medium feeding path 50.

If the printing operation is completed and the nozzle portion 12 stops ejecting the ink, the platen 13 descends, and the wiper 22 moves while contacting the nozzle portion 12 to wipe off a foreign substance like an ink drop attached to the nozzle portion 12. After the wiper 22 removes the foreign substance from the nozzle portion 12, the cap 26 moves to cap the nozzle portion 12 to shield the nozzle portion 12 from outdoor air. The wiper 22 wipes the nozzle portion 12 by moving in a same direction as the printing medium feeding direction and a direction opposite to the printing medium feeding direction while contacting the nozzle portion 12. When the wiper 22 wipes the nozzle portion 12, the foreign substance attached to the wiper 22 may come off and contaminate the printing medium feeding path. Accordingly, in the present embodiment, the printing medium guide 31 is tilted when the wiper 22 approaches the printing medium guide 31 while wiping the nozzle portion 12, to prevent the foreign substance from attaching to a printing medium contact portion of the printing medium guide 31. The tilting operation of the printing medium guide 31 is performed by a guide driving unit 40.

The platen 13 and the wiper 22 move by a link device 24 which is connected to a wiper driving gear 23. The wiper driving gear 23 is connected to a maintenance motor 25. By a forward/reverse rotation of the wiper driving gear 23, the platen 13 ascends and descends, and the wiper 22 performs the wiping operation. The cap 26 moves by a link device 28 which is connected to a cap driving gear 27. By the forward/reverse rotation of the cap driving gear 27, the cap 26 performs the capping operation. The cap driving gear 27 is connected to the maintenance motor 25 or another motor mounted in the image forming apparatus, to receive driving power.

The operations of the platen 13, the wiper 22 and the cap 26 are disclosed in detail in Korean Patent Laid-open Publication No. 2007-0021760 (Feb. 23, 2007), which has been filed by this applicant, and is herein incorporated by reference in its entirety. Hereinafter, the constitution and the operation of the printing medium guide 31, according to various embodiments of the present general inventive concept, will be primarily described in detail.

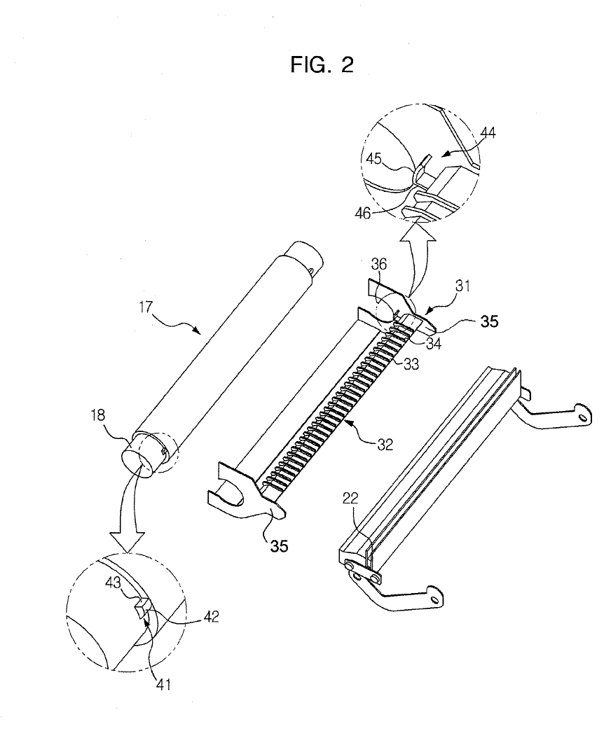

Referring to FIG. 2, the printing medium guide 31 is mounted in the printing medium feeding path 50 (FIG. 1) which extends from the printing medium supply device 14 to the printing medium discharge device 19. As illustrated in FIG. 2, the printing medium guide 31 includes a supporting portion 32 to support the printing medium which is fed, and a pair of side members 35 which are provided at both side portions of the supporting portion 32. The supporting portion 32 includes a supporting plate 33 which is disposed in parallel with the printing medium which is fed, and a plurality of supporting ribs 34 which are formed on an upper surface of the supporting plate 33 perpendicularly thereto. The supporting ribs 34 contact and support a lower surface of the printing medium which is fed so that the printing medium can be smoothly fed. The side members 35 are formed with coupling slots 36 into which supporting shafts 18 of a feed roller 17 to feed the printing medium are fitted. That is, the feed roller 17 is coupled rotatably in the forward or reverse direction to the printing medium guide 31, and the supporting shafts 18 extending from both side portions of the feed roller 17 are fitted into the coupling slots 36.

When the wiper 22 approaches the printing medium guide 31 while wiping the nozzle portion 12, the printing medium guide 31 is tilted such that the supporting portion 32 disposed adjacent to the nozzle portion 12 ascends. The printing medium guide 31 is tilted by the operation of the guide driving unit 40 (FIG. 1).

The guide driving unit 40 includes taper protrusions 41 which are provided at the feed roller 17, and latching members 44 which are provided at the printing medium guide 31 to interact with the taper protrusions 41.

The taper protrusions 41 are provided in pairs, each of which is formed at each of the supporting shafts 18 extending from the both side portions of the feed roller 17. Each taper protrusion 41 includes an inclined surface 42 to protrude gradually from a surface of each supporting shaft 18, and a latching surface 43 formed at an end of the inclined surface 42.

The latching members 44 are provided in pairs, each of which is mounted to each of the side members 35 correspondingly to each of the taper protrusions 41. Each latching member 44 includes an inclined portion 45 to slip on the inclined surface 42 of the taper protrusion 41 while in contact therewith, and a latching portion 46 which is connected to an end of the inclined portion 45. The latching member 44 is made of metal, plastic, or other materials that can be elastically deformed. A portion of the inclined portion 45 is coupled to the side member 35. The inclined portion 45 of the latching member 44 and the inclined surface 42 of the taper protrusion 41 have a curved shape, for example, such as a gradually-curved shape, so that the inclined portion 45 contacts and slips smoothly on the inclined surface 42 when the feed roller 17 rotates in the forward direction (clockwise direction).

If the feed roller 17 coupled to the printing medium guide 31 rotates in the forward direction, the inclined surface 42 of the taper protrusion 41 contacts the inclined portion 45 of the latching member 44 to press the inclined portion 45. The inclined portion 45 is elastically deformed to be pushed rearward and slips on the inclined surface 42, so that the rotational force of the feed roller 17 does not influence the printing medium guide 31. Accordingly, when the feed roller 17 rotates in the forward direction, the printing medium guide 31 does not move so that the supporting portion 32 is kept in parallel with the printing medium feeding path 50.

Alternatively, if the feed roller 17 rotates in the reverse direction (counterclockwise direction), the latching surface 43 of the taper protrusion 41 first contacts the latching portion 46 of the latching member 44, so that the rotational force of the feed roller 17 is exerted on the printing medium guide 31. At this time, by the latching surface 43 of the feed roller 17 pressing the latching portion 46 of the printing medium guide 31, the printing medium guide 31 rotates in a same direction as the rotational direction of the feed roller 17. The reverse rotational range of the feed roller 17 is limited such that the printing medium guide 31 rotates within a predetermined range of angle. The timing when the feed roller 17 stops the reverse rotation may be determined by detecting the rotational position of the printing medium guide 31 or the rotational position of the taper protrusion 41. For this, a position sensor (not illustrated) may be installed inside the ink-jet image forming apparatus.

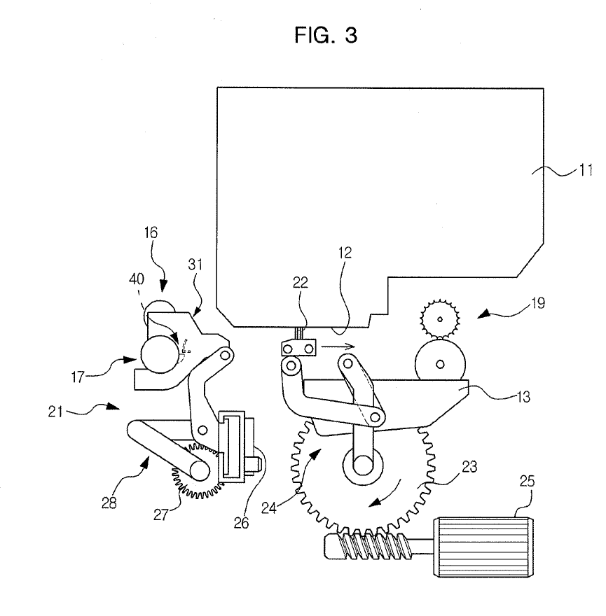

Hereinafter, an operation of the maintenance device 21 and the printing medium guide 31 of the ink-jet image forming apparatus according to an embodiment of the present general inventive concept will be described with reference to the FIGS. 3 to 5.

As illustrated in FIG. 3, if the ink ejection from the ink-jet head 11 is terminated, the wiper driving gear 23 rotates in a forward direction, and the platen 13 is separated from an area below the nozzle portion 12 by an operation of the link device 24. The wiper 22 moves in a same direction as the printing medium feeding direction 50 (FIG. 1) while contacting the nozzle portion 12, and wipes off a foreign substance such as an ink drop or a dust attached to the nozzle portion 12.

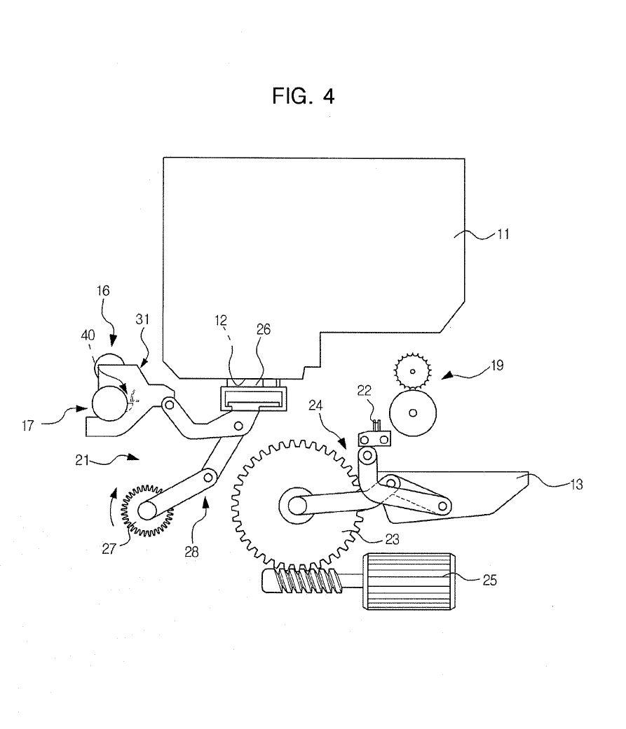

As illustrated in FIG. 4, if the platen 13 and the wiper 22 are located at a predetermined position spaced away from the area below the nozzle portion 12, the wiper driving gear 23 stops rotating. When the wiper 22 is separated from the nozzle portion 12, the cap driving gear 27 rotates in the forward direction, and the cap 26 moves to cap the nozzle portion 12 by the operation of the link device 28 connected to the cap driving gear 27. During the non-printing state, the cap 26 caps the nozzle portion 12 to protect the same. When the printing operation is restarted, the cap 26 is separated from the nozzle portion 12. Such a returning operation of the cap 26 is performed by a reverse rotation of the cap driving gear 27.

If the cap 26 is separated from the nozzle portion 12 and the printing operation is restarted, the wiper driving gear 23 rotates in the reverse direction, and the platen 13 moves to the position of the printing medium feeding path 50 by the link device 24 connected to the wiper driving gear 23. At the same time, the wiper 22 moves in the direction opposite to the printing medium feeding direction while contacting the nozzle portion 12, and wipes again the nozzle portion 12.

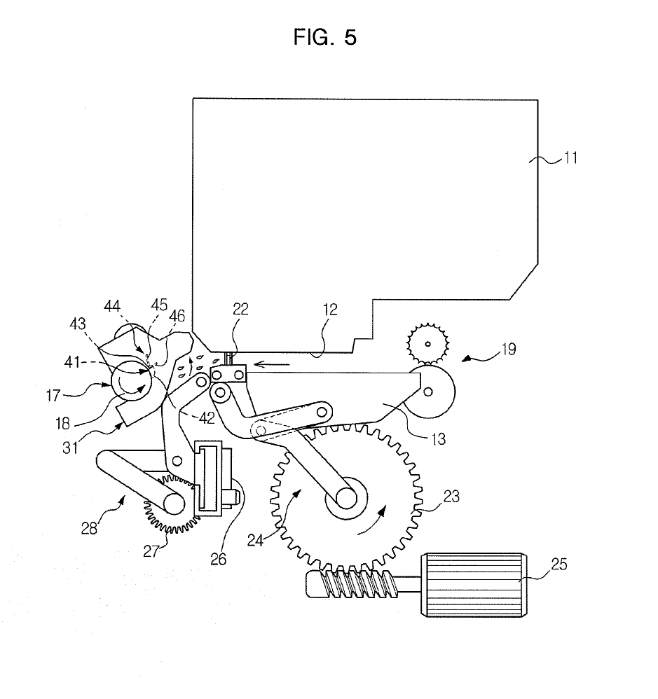

When the wiper 22 approaches the printing medium guide 31 while wiping the nozzle portion 12, the feed roller 17 rotates in the reverse direction at a predetermined angle. If the feed roller 17 rotates in the reverse direction, as illustrated in FIG. 5, the latching surface 43 of the taper protrusion 41 coupled to the feed roller 17 comes into contact with the latching portion 46 of the latching member 44 provided at the printing medium guide 31, and the printing medium guide 31 rotates at a predetermined angle by the rotational force of the feed roller 17. If the printing medium guide 31 rotates to be tilted at a predetermined angle, the feed roller 17 stops the reverse rotation, and the printing medium guide 31 also stops the rotation such that the supporting portion 32 is kept in the ascending state.

Accordingly, although the foreign substance comes off from the wiper 22 when the wiper 22 is separated from the nozzle portion 12, the foreign substance is not easily attached to the supporting portion 32. If the wiper 22 is separated from the nozzle portion 12 and returns to the original position, the feed roller 17 rotates in the forward direction to feed the printing medium toward the nozzle portion 12, and the printing medium guide 31 returns to the original position by a weight of the printing medium guide 31 to guide the printing medium which is fed.

The wiping operation of the wiper 22 can be repeated several times after completion of the printing. Whenever the wiper 22 approaches the printing medium guide 31 while contacting the nozzle portion 12, the printing medium guide 31 is tilted so that the supporting portion 32 ascends.

The guide driving unit 40 to tilt the printing medium guide 31 is not restricted to the taper protrusion 41 and the latching member 44. Other types of mechanism capable of tilting the printing medium guide 31 with a device interlocking with the feed roller 17 or an additional driving source, can be used as the guide driving unit 40.

Referring to FIG. 5, the printing medium guide 31 can be mounted on a downstream side of the ink-jet head 11 in the printing medium feeding path 50 (FIG. 1). In this case, the printing medium guide 31 mounted on a downstream side of the ink-jet head 11 is also tilted so that a portion adjacent to the ink-jet head 11 ascends, when the wiper 22 approaches the printing medium guide 31.

Also, the present general inventive concept can be modified such that the printing medium guide 31 rotates in the reverse direction to the rotational direction as described above and is tilted to prevent the foreign substance from being attached to the supporting portion 32.

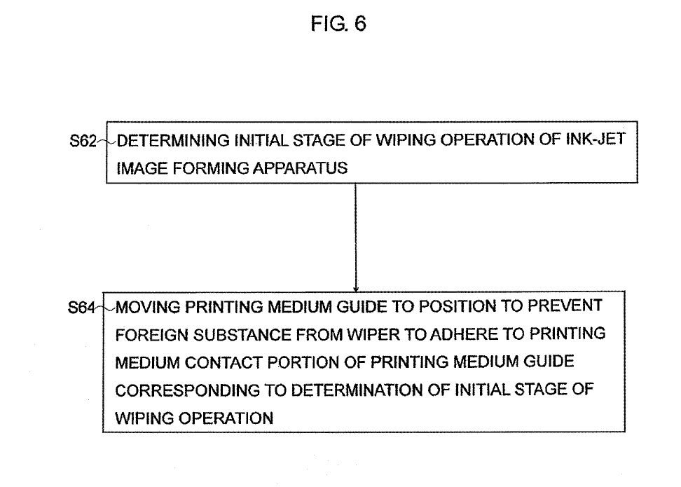

FIG. 6 is a flowchart illustrating a method of cleaning an ink-jet image forming apparatus according to an embodiment of the present general inventive concept. Referring to FIG. 6, in operation S62, an initial stage of a wiping operation of an ink-jet image forming apparatus is determined. In operation S64, the printing medium guide 31 is moved to a position to prevent a foreign substance from the wiper 22 to adhere to the printing medium contact portion of the printing medium guide 31 corresponding to the determination of the initial stage of the wiping operation. In the present embodiment, the initial stage of the wiping operation can be movement of the wiper 22 towards the printing medium guide 31 and a nozzle portion 12 of an ink-jet head 11 to clean the nozzle portion 12.

The present general inventive concept can be applied to both an ink-jet image forming apparatus equipped with a shuttle type ink-jet head and an ink-jet image forming apparatus equipped with an array type ink-jet head.

As apparent from the above description, the ink-jet image forming apparatus according to various embodiments of the present general inventive concept has an effect that a foreign substance coming off a wiper is not easily attached to a printing medium contact portion of a printing medium guide, because the printing medium guide is tilted when the wiper moves toward the printing medium guide while wiping the nozzle portion. Accordingly, various embodiments of the present general inventive concept prevents a foreign substance coming off a wiper from attaching to a printing medium guide and contaminating a printing medium passing through the printing medium guide.

The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although various embodiments of the present general inventive concept have been illustrated and described, it would be appreciated by those skilled in the art that changes may be made in these embodiments without departing from the principles and spirit of the general inventive concept, the scope of which is defined in the claims and their equivalents.

What is claimed is:

1. An ink-jet image forming apparatus, comprising:
an ink-jet head having a nozzle portion to eject ink into a printing medium;
a wiper to wipe the nozzle portion of the ink-jet head; and
a printing medium guide movable between a first position to guide the printing medium and a second position to prevent a foreign substance from the wiper adhering to a printing medium contact portion of the printing medium guide.

2. The ink-jet image forming apparatus according to claim 1, further comprising:
a guide driving unit to tilt the printing medium guide to prevent a foreign substance coming off the wiper from being attached to a printing medium contact portion of the printing medium guide when the wiper wipes the nozzle portion.

3. The ink-jet image forming apparatus according to claim 2, wherein the guide driving unit tilts the printing medium guide when the wiper approaches the printing medium guide while wiping the nozzle portion.

4. The ink-jet image forming apparatus according to claim 2, wherein the guide driving unit rotates the printing medium guide at a predetermined angle to raise a portion of the printing medium guide adjacent to the ink-jet head.

5. The ink-jet image forming apparatus according to claim 4, wherein the printing medium feeding device includes a feed roller to rotate to feed the printing medium, and
the guide driving unit rotates the printing medium guide by a rotational force of the feed roller.

6. The ink-jet image forming apparatus according to claim 5, wherein when the feed roller rotates in a forward direction to feed the printing medium, the guide driving unit is in a non-operating state, and
when the feed roller rotates in a reverse direction, the guide driving unit operates to rotate the printing medium guide at the predetermined angle.

7. The ink-jet image forming apparatus according to claim 6, wherein the guide driving unit includes a taper protrusion provided at the feed roller having an inclined surface protruding gradually from a surface of the feed roller and a latching surface formed at an end of the inclined surface, and a latching member provided at the printing medium guide having an inclined portion and a latching portion connected to an end of the inclined portion,
whereby when the feed roller rotates in the forward direction, the inclined portion contacts and slips on the inclined surface, and
when the feed roller rotates in the reverse direction, the latching portion is caught by the latching surface.

8. The ink-jet image forming apparatus according to claim 7, wherein the inclined portion is elastically deformable, and
when the inclined portion contacts the inclined surface, the inclined portion is pushed outwardly from the feed roller.

9. A maintenance method of an ink-jet image forming apparatus, the method comprising:
wiping a nozzle portion of an ink-jet head by a wiper; and
tilting a printing medium guide to prevent a foreign substance coming off the wiper from being attached to a printing medium contact portion of the printing medium guide when the wiper wipes the nozzle portion.

10. The maintenance method according to claim 9, wherein the tilting includes tilting the printing medium guide when the wiper approaches the printing medium guide while wiping the nozzle portion.

11. The maintenance method according to claim 9, wherein the tilting includes rotating the printing medium guide at a predetermined angle to raise a portion of the printing medium guide adjacent to the ink-jet head.

12. The maintenance method according to claim 11, wherein the rotating is performed by reversely rotating a feed roller to rotate in a forward direction to feed a printing medium.

13. A printing medium guiding device usable with an ink-jet image forming apparatus, the device comprising:
a printing medium guide to guide a printing medium, and having a printing medium contact portion to contact the printing medium,
wherein the printing medium guide is movable between a first position to guide the printing medium and a second position to prevent a foreign substance from a wiper of the ink-jet forming apparatus from adhering to the printing medium contact portion of the printing medium guide.

14. The device of claim 13, wherein the printing medium guide moves to the second position corresponding to an initial stage of a wiping operation.

15. The device according to claim 14, wherein the initial stage of the wiping operation is a movement of the wiper towards the printing medium guide.

16. A method of cleaning an ink-jet image forming apparatus, the method comprising:
determining an initial stage of a wiping operation of an ink-jet image forming apparatus; and
moving a printing medium guide to a position to prevent a foreign substance from a wiper to adhere to a printing medium contact portion of the printing medium guide corresponding to the determination of the initial stage of the wiping operation.

17. The method of claim 16, wherein:
moving the wiper toward the printing medium guide is the initial stage of the wiping operation.

18. A computer-readable recording medium having embodied thereon a computer program to execute a method, wherein the method comprises:
determining an initial stage of a wiping operation of an ink-jet image forming apparatus; and
moving a printing medium guide to a position to prevent a foreign substance from a wiper to adhere to a printing medium contact portion of the printing medium guide corresponding to the determination of the initial stage of the wiping operation.
